(19) United States
(12) Patent Application Publication
(10) Pub. No.: US 2024/0359354 A1
(43) Pub. Date: Oct. 31, 2024

(54) A ROTATING BLADE DEVICE, A MACHINE COMPRISING SAID DEVICE, AND METHOD

(71) Applicant: VALMET TISSUE CONVERTING S.P.A, Lucca (IT)

(72) Inventors: Franco MONTAGNANI, Palaia (IT); Matteo GALOPPINI, Lucca (IT)

(73) Assignee: VALMET TISSUE CONVERTING S.P.A, Lucca (IT)

(21) Appl. No.: 18/687,425

(22) PCT Filed: Aug. 10, 2022
(86) PCT No.: PCT/EP2022/072423

§ 371 Date: Feb. 28, 2024

(30) Foreign Application Priority Data
Aug. 31, 2021 (IT) 102021000022598

(51) Int. Cl. B26F 1/20; B26D 1/00; B26D 1/38; B26D 5/20; B26D 7/26; B65H 35/00

(52) U.S. Cl. CPC B26F 1/20; B26D 1/0006; B26D 1/385; B26D 5/20; B26D 7/2628; B65H 35/0086; B26D 2001/0066; B26D 2001/0073; B65H 2301/122; B65H 2701/1944

(57) ABSTRACT

The device includes a fixed counter-blade and a rotating blade-holder on which a set of rotating blades is arranged. A web material which must be perforated or cut into sheets passes between blade-holder and counter-blade. A mutual contact sensor and an angular position sensor provide signals that allow correct positioning and functioning of the rotating blades and the counter-blade to be displayed on a human-machine interface.

### TECHNICAL FIELD

The present disclosure concerns blade devices for perforating or cutting a continuous web material. Embodiments concern perforating devices or cutting devices, for perforating or cutting a web material made of paper, for example and in particular tissue paper. Other embodiments concern cutting devices for cutting a web material with polymer, cellulose, bio-plastic or other base, for forming individual wrapping sheets for wrapping groups of products such as toilet paper rolls, packs of serviettes, and the like.

### BACKGROUND ART

In the industry for converting and processing continuous web materials such as, for example, continuous webs or plies of cellulose material such as, e.g., tissue paper, it is common practice to feed a continuous web material to a perforating device, which carries out perforation of the web material in a direction transverse to the feed direction, to divide the continuous web material into individual sheets that can be separated by tearing at the moment of use. Kitchen paper rolls, toilet paper rolls and the like, for example, formed of sheets that can be separated along the perforation line, are produced according to this criterion.

In the context of the present description and the attached claims, a perforation line is a line in which portions of cut web material and portions of uncut web material alternate respectively. The perforation lines constitute weakened lines along which the web material can be torn, for example to separate from one another the individual sheets into which a continuous web of cellulose material is divided.

Preferably the portions of cut web material are longer than the uncut ones. In this way, the perforation lines create weakened areas of the web material which can therefore be easily torn both for the intended uses and for carrying out some ordinary processing operations. For example, in the field of paper converting, such as tissue paper converting, the perforation lines are used to tear the web material at the end of winding of a roll and to begin winding of the next roll.

The creation of a correct perforation line is important for obtaining a good quality product, where it is easy to separate one sheet from another along the perforation lines. When the perforation line is used also in the conversion process, for example to interrupt the continuous web material at the end of winding of a roll and to begin the winding of the next roll, the creation of a correct good quality perforation line is fundamental to avoid jamming during automatic and continuous processing of the web material in the winding phase during exchange, namely the passage from one roll to the next roll.

The perforation device is usually positioned in or on a rewinder or other converting machine.

Examples of perforation devices and rewinders comprising said devices are disclosed in EP0454633, U.S. Pat. Nos. 5,284,304, 5,125,302, 6,431,491, WO 00/73029.

The perforation devices usually comprise a rotating blade-holder, on which one or more blades are mounted. The blades co-act with a fixed counter-blade. The web material is made to pass between the blade-holder and the counter-blade to be perforated according to transverse perforation lines, normally equidistant from one another and orthogonal to the feed direction of the web material.

The rotating perforation blades and the counter-blade must perform correct perforation, without damaging the web material and without leaving non-perforated sections. For this purpose, accurate adjustment of the blades and counter-blade is necessary. This operation is long and complex and may require the intervention of specialist personnel.

The blades and the counter-blade are subject to wear and may therefore require adjustments or regulations repeated over time and they have to be replaced periodically. Replacement also requires tuning and adjustment before re-starting the machine on which the perforation device is mounted. The blades and/or the counter-blade can also be subject to breakage, due to the dynamic stress exerted on them. In this case they must be promptly replaced.

Incorrect adjustment of the blades and counter-blade can result in abnormal mechanical stress, vibrations, excess wear, damage to the machine and low quality of the finished product.

It is important to promptly identify the malfunction of the perforation device or increase the adjustment speed in order to avoid discarding large numbers of products and to prolong machine life.

U.S. Pat. No. 5,125,302 illustrates a perforating machine in which a plurality of rectilinear blades are carried by a rotating roller or blade-holder, and co-act with a helical counter-blade. In this document the possibility of providing a sensor for detecting abnormal operating conditions is generically indicated, in order to promptly move the helical counter-blade away from the rotating blade-holder. No type of processing of the signal detected by the sensor is mentioned, and neither is there any description of the type of signal used.

In some machines for converting paper, in particular tissue paper, blade devices are provided for cutting a web material into individual sheets, separate from one another, instead of joined along perforation and tear lines. For example, cutting devices with rotating blades and fixed counter-blade are used in interfolding machines for the production of packs of folded and interfolded sheets. In some embodiments of these machines, the cut is performed with a rotating blade-holder that supports a plurality of blades with constant pitch, which co-act with a fixed counter-blade. In these cutting devices problems can occur similar to those encountered in the perforating devices. Cutting units of this type, in the context of interfolding machines, are disclosed for example in EP2379435B1, EP2502738B1.

In the field of the production and packaging of rolls or other articles made of tissue paper, the use of packaging machines is known in which groups of tissue paper articles, for example groups of rolls, are packaged in wrapping sheets, typically made of polymer, bio-plastic, paper or other. Examples of packaging machines of this type are disclosed in IT1426528, EP2766266, EP1228966. These packaging machines comprise a cutting assembly which divides a web material into individual wrapping sheets.

In all the cutting devices mentioned above, problems can occur due to incorrect adjustment of the position of the blades, breakage of the blades or wear thereof, similarly to what is more widely mentioned in relation to the perforation devices.

It would be desirable to provide perforation devices and cutting devices of the above-mentioned type which are improved in terms of their control and correct operation, in particular for example as regards the mutual positioning between blades and counter-blade, in order to alleviate or eliminate one or more of the drawbacks or limits of the devices of the current art.

WO-A-2019/239283 discloses cutting and perforation units of the type mentioned above, which have advantageous features and improvements with respect to the prior art devices. However, there is still room for further improvement of the cutting and perforation units to simplify the control and management thereof and to increase their dependability and operating precision.

### SUMMARY

To obtain improved perforation or cutting control, and to attain further advantages and technical results that will appear clear from the following detailed disclosure of embodiments, a rotating blade device is provided for processing a web material, comprising a support structure on which a rotating blade-holder is revolvingly mounted, on which a set of rotating blades is arranged. The device further comprises a counter-blade carried on the support structure and adapted to co-act with the set of rotating blades. Each rotating blade and the counter-blade are configured so that, during rotation of the rotating blade-holder, each rotating blade and the counter-blade come into mutual contact at a first end of the rotating blade, and out of mutual contact at a second end of the rotating blade, so that the point of mutual contact between each rotating blade and the counter-blade moves gradually from the first end to the second end of the rotating blade along a longitudinal extension of the rotating blade.

Advantageously, the device comprises a mutual contact sensor, adapted to detect the presence or absence of mutual contact between each rotating blade and the counter-blade. An angular position sensor is also provided, for example an angular encoder, adapted to detect an angular position of the rotating blade-holder. A device, for example a control unit, is provided for combining a signal of the mutual contact sensor and a signal of the angular position sensor and providing, for each rotating blade, an indication of the presence or absence of contact between the rotating blade and the counter-blade in a plurality of points distributed along a longitudinal extension of the respective rotating blade and counter-blade.

According to a further aspect, a method for processing continuous web material is described, comprising the following steps:
feeding the continuous web material along a feed path between a counter-blade and a rotating blade-holder comprising a set of rotating blades co-acting with the counter-blade;
acting on the web material by co-action of each rotating blade with the counter-blade; in which the set of rotating blades and the counter-blade act on the web material with a scissor cut, such that each rotating blade and the counter-blade co-act with one another in a point that, during rotation of the rotating blade, translates from a first end of the respective rotating blade to a second end of the respective rotating blade along a longitudinal extension of the respective rotating blade and counter-blade;
generating a signal indicative of the presence or absence of mutual contact between each rotating blade and the counter-blade by means of a mutual contact sensor during the interaction between each rotating blade and the counter-blade while the point of contact between blade and counter-blade translates from the first end to the second end of the respective rotating blade;
associating information on the angular position of the rotating counter-blade with the signal of presence or absence of mutual contact.

Further advantageous features and embodiments of the device and method defined above are described below and set out in the appended claims.

Machines for converting or processing a web material are also described, which comprise a device of the type outlined above which operates according to the method as defined above. The machines comprise rewinders, packaging machines and interfolding machines, for example.

### BRIEF DESCRIPTION OF THE DRAWINGS

The invention will be better understood by following the description and the attached drawings, which illustrate exemplifying and non-limiting embodiments of the invention. More specifically, the drawings show: 25

FIG. 1 a schematic lateral view of a rewinder comprising a perforation device according to the present description;

FIG. 2 a view according to II-II of FIG. 1;

FIGS. 3, 4, 5 and 6 diagrams illustrating a signal detected by the sensor of the perforation device of FIG. 1 in three different operating conditions;

FIG. 7 a schematic lateral view of a perforation device in a further embodiment;

FIG. 8 a diagram illustrating a signal detected by the sensor of the perforation device of FIG. 7;

FIG. 9 a schematic representation of a human-machine interface with graphic representation of the conditions of mutual interaction between a fixed counter-blade and a plurality of rotating blades;

FIG. 10 a diagram of a further embodiment of a device comprising a fixed counter-blade and a plurality of rotating blades with a double sensor for detecting mutual contact between rotating blades and counter-blade;

FIG. 11 a view of an interfolder machine with cutting devices, to which a system of sensors can be applied for detecting the angular position of the rotating blades and angular position sensors;

FIG. 12 a lateral view of a packaging machine comprising a cutting device with rotating blades and counter-blade for dividing a web material into individual wrapping sheets; and

FIG. 13 a view according to XIII-XIII of FIG. 12.

### DETAILED DESCRIPTION

Various embodiments are described below of cutting devices and perforation devices of a continuous web material, for example a web material of tissue paper, a polymer film, a bio-plastic film and the like. In short, the cutting or perforation device comprises at least a fixed counter-blade and a rotating blade-holder, on which a set of rotating blades is mounted comprising at least one rotating blade. The arrangement of the rotating blade(s) and the fixed counter-blade is such as to produce a scissor cut. In other words, blade and counter-blade touch at a point which, during cutting, translates from one end to the other of the cutting edge of the blade and counter-blade. In practice, due to the need to exert a force between blade and counter-blade during the cutting or perforation, and due to the flexibility of the blades and/or counter-blades, the mutual point of contact between blade and counter-blade during cutting actually extends for a certain length. Although indicated as “point”, the area of co-action or contact between blade and counter-blade therefore always has an extension according to the longitudinal extension of the blade and/or counter-blade.

For a more effective control of operation of the cutting or perforation device, and therefore for a more efficient management of the machine in which the device is inserted, a sensor for detecting the mutual contact between blade and counter-blade, below indicated in short as mutual contact sensor, and an angular position sensor, which detects the angular position of the rotating blade-holder, are provided in combination. Each of said sensors can in practice be single or multiple, namely can comprise in turn a plurality of sensor or detection devices or members, also of different nature from one another, to obtain a greater quantity of information. For example, the mutual contact sensor can comprise a sensor that detects an electrical parameter and/or one or more load, namely force, sensors, for example in the form of load cells.

By combining the signal provided by the mutual contact sensor and the angular position sensor, it is possible to provide indications of the correct operation of the device, or the presence of an incorrect mutual positioning of blades and counter-blade, or again the presence of breakages or defects of the counter-blade and blade(s). Furthermore, the use of an angular position signal allows for identification of the point or the area along the longitudinal extension of the cutting edges of the blades and counter-blade in which a possible defect or breakage occurs.

In general, by cutting or perforation defects, a point is understood, in which the cut or the perforation of the web material is lacking or not sufficiently formed. Points in which the cut or the perforation are not sufficiently formed can be caused by pressure deficiency between blade and counter-blade. In this case, instead of having a correctly formed cut or perforation, the web material can be intact or have only a surface incision. This effect is a clear example of malfunctioning due to lack of pressure between blades and counter-blade due to wear or incorrect assembly or incorrect adjustment of the cutting or perforation unit. The lack of adequate pressure can be the consequence of incorrect mutual positioning of blades and counter-blade, or wear on the blades and/or on the counter-blade. A cutting or perforation defect can also be due to breakage of the cutting edge of a blade and/or of the counter-blade.

Referring now to the attached drawings, embodiments of a perforation device will be initially described, namely a device adapted to produce perforation lines, preferably equidistant from one another, along a web material, for example to divide it into a plurality of sheets that can be separated by tearing along the perforation lines at the moment of use. Subsequently, embodiments of cutting systems for separating portions or sheets of a web material from one another will be described.

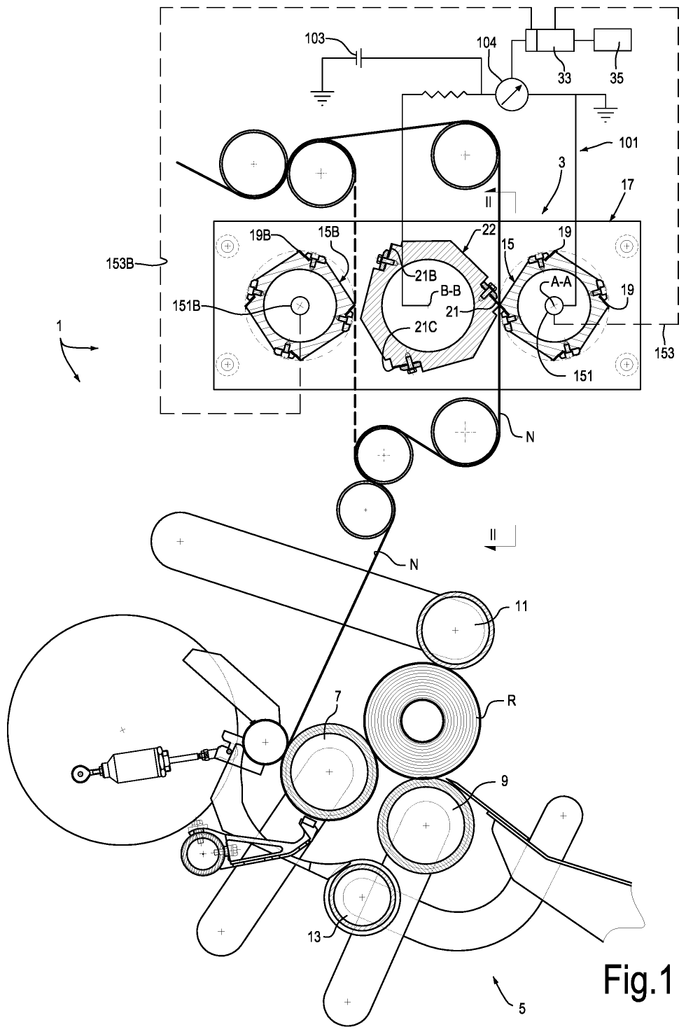

FIG. 1 schematically shows a rewinder 1, equipped with a perforation device 3. The rewinder 1 is shown as an example of a generic machine for processing or converting a continuous web material N. The structure of the rewinder 1 is illustrated merely by way of example and can vary in a manner known per se to those skilled in the art. In general, the rewinder 1 can be a peripheral rewinder, preferably an automatic continuous peripheral rewinder, namely able to produce automatically and without stops, in rapid sequence, rolls R of wound web material N. The rewinder 1 can comprise a winding head 5 equipped with a plurality of motorized winding rollers 7, 9, 11, 13 and other members known per se to those skilled in the art. Embodiments of rewinders are disclosed for example in EP2621844, EP0694020, EP2655227. In other embodiments, not shown, the rewinder can be a central rewinder, namely in which the winding motion is imparted to the rolls from the centre of a spindle or winding core. In further embodiments, the rewinder can be a combined peripheral and central rewinder, in which the winding motion is transmitted partly by friction through contact between the outer surface of the roll being formed and peripheral winding members (such as rollers or belts) and partly by means of a pair of centers or other members that axially engage the roll.

Although in this context the perforation device 3 is described in combination with a rewinder 1, which produces rolls of wound material, in other embodiments the perforation device 3 can be combined with one or more machines for converting a web material to produce different articles. For example, the perforation device 3 can be associated with a machine for the production of packages formed of a continuous web material that is perforated and folded in a zig-zag pattern.

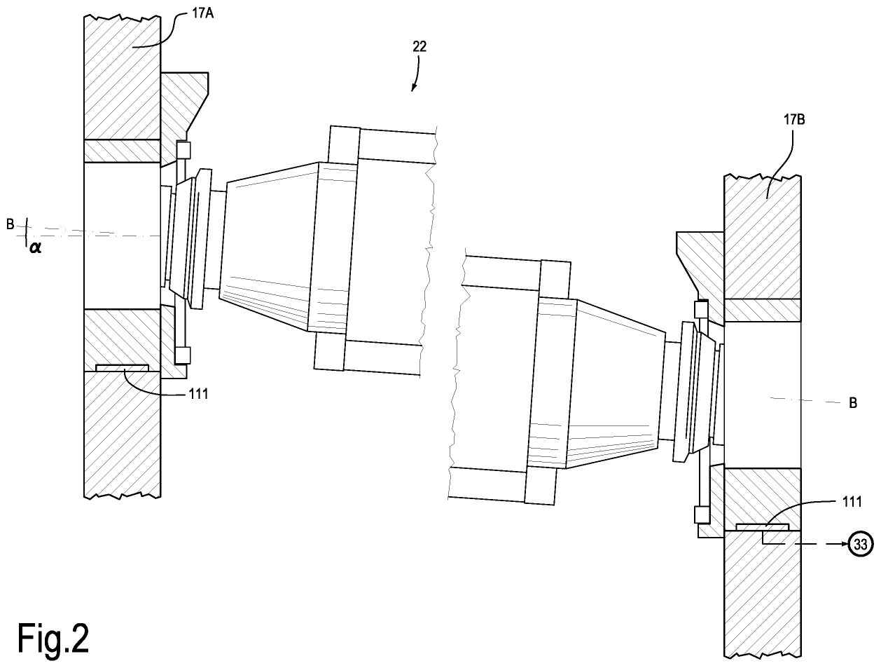

The perforation device 3 comprises a rotating blade-holder 15, supported on a supporting structure 17, for example comprising two opposite sides 17A, 17B (FIG. 2), between which the blade-holder 15 is arranged. The blade holder 15 rotates around a rotation axis A-A. The blade-holder 15 is equipped with a set of perforation blades. In general terms, the set of perforation blades can also comprise a single perforation blade. In preferred embodiments, the blade-holder 15 is provided with a plurality of perforation blades. In the illustrated example, the blade-holder 15 is provided with four perforation blades 19, preferably arranged spaced from one another by the same pitch around the rotation axis A-A of the rotating blade holder 15, but it is possible to have a blade-holder provided with a greater number of blades, for example six or eight blades.

In the illustrated embodiment, the perforation device 3 comprises a second rotating blade-holder 15B, equipped with a second set of rotating blades 19B. The two rotating blade-holders 15, 15B can be used alternately, if necessary according to the type of product to be produced, causing the web material N to be perforated to follow one or the other of two alternative paths, indicated in FIG. 1 by a solid and a broken line, respectively.

The perforation device 3 further comprises a counter-blade 21 carried by the support structure 17 and extending, similarly to the blade-holder 15, between the two sides 17A, 17B and supported thereby. The counter-blade 21 is preferably fixed or stationary with respect to the support structure 17. In the sense understood here, the term “fixed” or “stationary” means that the counter-blade does not participate in the rotation movement that generates the perforation of the web material N. This does not exclude the counter-blade from having some movement. For example, the counter-blade 21 can have an alternate translation movement parallel to its longitudinal extension, so as to avoid concentration of the wear due to the indented form of the perforation blades 19. The counter-blade 21 can have a translation and/or rotation movement in order to carry out an adjustment or regulation, and/or to select one or the other of several counter-blades present in the perforation device 3, as illustrated in further detail below.

To obtain perforation lines, instead of complete cutting of the web material, the perforation blades 19 or the counter-blade 21 have an indented, i.e. discontinuous, cutting edge with notches, in the area of which the web material remains intact, namely it is not cut, forming points of continuity of the web material.

In the illustrated embodiment, the counter-blade 21 is carried by a beam 22, extending in a direction approximately parallel to the rotation axis A-A of the blade-holder 15. In some embodiments, as illustrated in the attached drawing, other additional counter-blades can be provided, indicated by 21B, 21C, carried for example by the same beam 22. The latter can be adjusted in an angular position with a step movement around an axis B-B, so as to selectively operate one or the other of the counter-blades 21, 21B, 21C.

If the perforation device 3 comprises two rotating blade-holders 15, 15B, it is possible to use alternatively one or the other of the counter-blades 21, 21B, 21C in combination with the rotating blades 19 or 19B alternatively of the blade-holder 15 or the blade-holder 15B.

The presence of several perforation counter-blades 21, 21B, 21C can be useful for example for rapidly replacing a worn counter-blade with another counter-blade. In some embodiments the counter-blades 21, 21B, 21C can have different characteristics from one another, for example different indentations to allow the type of production to be changed, when this change also requires the type of perforation to be changed.

The beam 22 can be mounted on the sides 17A, 17B by means of eccentric supports, so that a slight rotation of the beam 22 moves the blade 21, 21B, 21C nearer or farther away by adjusting the interference between the rotating blades 19 and the counter-blade 21, 21B, 21C.

The web material N is fed along a path that extends between the rotating blade-holder 15 and the counter-blade 21, so that it is subject to the action of the rotating blades 19 and the counter-blade 21.

To obtain a gradual perforation action across the width of the web material N, the counter-blade 21 can be helical and the blades 19 can be rectilinear, namely they can be arranged parallel to the rotation axis A-A of the blade-holder 15. The counter-blade 21 is helical in the sense that its cutting edge extends according to a helical line, arranged on an ideal cylindrical surface coaxial with the axis B-B of the beam 22. A perforation device 3 with a helical counter-blade and rectilinear rotating perforation blades is described in U.S. Pat. No. 5,125,302.

In other embodiments, as shown in the attached figures, the arrangement is reversed, in the sense that the perforation blades 19 are helical, while the counter-blade is rectilinear. In this case the perforation blades 19 are helical in the sense that their cutting edges can extend each along a helical line lying on a cylindrical surface coaxial with the rotation axis A-A of the blade-holder 15.

In both cases, the arrangement is such that, arranging the edge of the counter-blade 21 and the cylindrical surface on which the cutting edges of the blades 19 lie at a distance such as to bring the blades and counter-blade into mutual contact, each perforation blade 19 comes into contact with the counter-blade 21 at a point that moves gradually along the longitudinal extension of the perforation blade 19 and counter-blade 21. In practice, the contact between the cutting edge of each blade 19 and the counter-blade 21 begins at one end of the perforation blade 19 and counter-blade 21 and terminates at the opposite end. In this way, independently of which is the helical element and which is the rectilinear element of the blade/counter-blade pair, each perforation line is generated gradually, with a scissor cut, thus making operation of the perforation device 3 more uniform and reducing the stress on the web material N.

As mentioned above, due to the fact that in the contact area between blade 19 and counter-blade 21 it is necessary to develop a certain force, the counter-blade and/or the rotating blades 19 deform by flexion at the point of contact; the latter is not a point in a geometrical sense, but extends over a section that can have a length of a few millimeters.

Preferably the angle of the helix formed by the edges of the perforation blades 19 (or alternatively the counter-blade 21) and the angular pitch between the perforation blades 19 are chosen so that in any angular position of the blade-holder 15 there is always a point of contact between at least a perforation blade 19 and the counter-blade 21. This makes operation of the perforation device 3 more uniform and regular, less noisy and reduces the stress on the mechanical components of the perforation device 3.

In order for the perforation lines generated by the perforation device 3 on the web material N to be orthogonal to the feed direction of the web material N and therefore orthogonal to its longitudinal edges, the rotation axis A-A of the blade-holder 15 and the axis B-B of the beam 22 that carries the counter-blade 21 are parallel to each other and inclined with respect to the feed direction F of the web material N by an angle different from 90° and more exactly by an angle corresponding to 90°−α, where α is the angle of inclination of the perforation blades 19, or of the counter-blade 21, when the latter has a helical form. This inclined set-up is shown in particular in FIG. 2, where the sides 17A, 17B of the supporting structure and the axis B-B of the beam 22 that supports the counter-blade 21 are shown.

Advantageously, according to the description herein, the perforation device 3 is associated with a sensor arrangement that has the function of detecting the presence or absence of mutual contact between each rotating blade 19, 19B and the respective fixed counter-blade 21, 21B, 21C. More specifically, the arrangement that will be described below allows a signal of angular position of the rotating blade-holder 15, 15B to be associated with a signal of presence or absence of mutual contact between blade and counter-blade so as to present, for example on an appropriate human-machine interface, an indication which for each rotating blade indicates (for a plurality of points along the longitudinal extension of the cutting edge of the blade) whether there is or there is not mutual contact between rotating blade and counter-blade.

As will be clearer from what is illustrated below, this allows to verify both whether the mutual position of the rotating blade-holder 15, 15B is correct, and whether the blade or the counter-blade have breakages along their respective cutting edges.

The term “points” must therefore be understood in a mechanical and not a geometrical sense, namely taking account of the fact that the mutual contact between blade and counter-blade is not punctiform, but extends for a certain section of the cutting edge according to the elastic deformation which the blade and/or the counter-blade undergoes due to the force with which blade and counter-blade are pressed against each other.

For said purpose, more specifically, in embodiments described here, the following are provided:
a mutual contact sensor, adapted to detect the presence or absence of mutual contact between each rotating blade and the counter-blade in various points along their longitudinal extension;
an angular position sensor, for example an angular encoder, which detects the angular position of the rotating blade-holder 15, 15B.

The mutual contact sensor can use one or more load cells or other devices adapted to detect and/or measure a force exchanged between rotating blade and counter-blade. In other embodiments, the mutual contact sensor can comprise a device adapted to detect an electrical parameter, for example a difference in potential. In other embodiments, the mutual contact sensor can comprise a combination of several devices that detect an electrical parameter and a force exchanged between blade and counter-blade.

In general, a mutual contact sensor indicates a single sensor or a plurality of sensors combined with one another.

FIGS. 1 to 6 show an embodiment in which the mutual contact sensor used is a sensor adapted to detect an electrical parameter, for example a voltage, indicative of the mutual interaction between rotating perforation blades 19 and fixed counter-blade 21; 21B; 21C.

FIG. 1 schematically illustrates a sensor 104 connected to the system comprising the rotating blade-holder with the perforation blades 19 and the fixed counter-blade 21; 21B; 21C, so as to detect an electrical voltage between the counter-blade 21 (or 21B, 21C, depending which of said counter-blades is in use) and the rotating perforation blades 19 (or 19B). In the schematic exemplifying embodiment of FIG. 1 the sensor 104 is inserted in a measurement circuit 101, which comprises a voltage source 103, for example a direct voltage source, preferably a low voltage. In some embodiments, the voltage of the source 103 is 24 Volt. The sensor 104 is functionally connected to an electronic control unit 33 and provides a voltage signal. The control unit 33 is connected to one or more human-machine interfaces, schematically and overall indicated by the number 35.

The voltage detected by the sensor 104 is approximately equal to the voltage of the source 103 when there is no contact between rotating perforation blades 19 and counter-blade 21, whereas it is substantially lower when the measurement circuit in which the counter-blade 21 and the rotating perforation blades 19 are inserted is closed, namely when there is contact between counter-blade 21 and at least one of the rotating perforation blades 19.

Although in FIG. 1 the sensor 104 is shown connected to the blade-holder 15, it must be understood that the same sensor 104 can be configured so as to be connected alternatively to the rotating blade-holder 15 or to the rotating blade-holder 15B, depending on which of the two blade-holders 15, 15B is in use. Alternatively, the circuit 101 can be dual: a first circuit 101 can be associated with the rotating blade-holder 15 and a second circuit 101, identical to the first circuit 101, can be associated with the rotating blade-holder 15B.

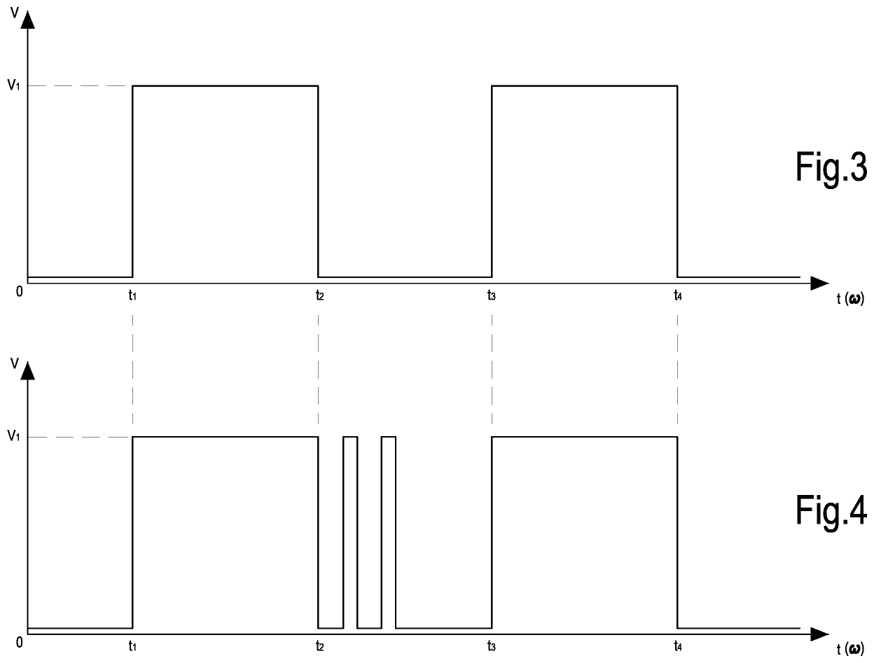

FIG. 3 schematically shows the voltage signal generated by the sensor 104 if the perforation device 3 is configured so that there is no continuous contact between rotating perforation blades 19 and fixed counter-blade 21. This situation can occur for example if there are only one or two rotating perforation blades 19, so that for each complete rotation of the blade-holder 15 there are one or two time intervals in which there is no mutual contact between rotating perforation blades 19 and counter-blade 21.

In the diagram of FIG. 3 time is plotted on the X-axis shows and the voltage signal detected by the sensor 104 is plotted on the Y-axis. In the time intervals (t1-t2) and (t3-t4) there is no contact between rotating perforation blades 19 and counter-blade 21, whereas in the interval (t2-t3) the perforation is carried out. FIG. 3 shows a correct operating condition.

If a perforation blade is broken and/or if the counter-blade is broken or if the perforation device is not correctly adjusted, the voltage signal deforms and presents voltage peaks in the interval (t2-t3) as shown schematically in FIG. 4. The electronic control unit 33 is adapted to detect this anomaly and generate an alarm or provide a notification.

In general, the blades 15, 15B are indented, to carry out perforations instead of continuous cuts (alternatively, the counter-blade 21, 21B, 21C can be indented). The discontinuities formed by the interruptions of the cutting edges of the blades 15, 15B do not cause an absence of contact signal. This is because the length of the interruptions of the cutting edges is shorter than the length of the contact area between blade and counter-blade. As said, this non-punctiform contact area is due to the deformation of the blade (or the counter-blade), due to the force with which blade and counter-blade are pressed against each other to correctly perform perforation of the web material N. Consequently, the presence of the short interruptions of the cutting edge due to the indentation of the perforation blades does not significantly alter the signal generated by the mutual contact sensor and therefore the interruptions of the cutting edge that form the indentation of the blades do not generate false alarms indicating blade breakage.

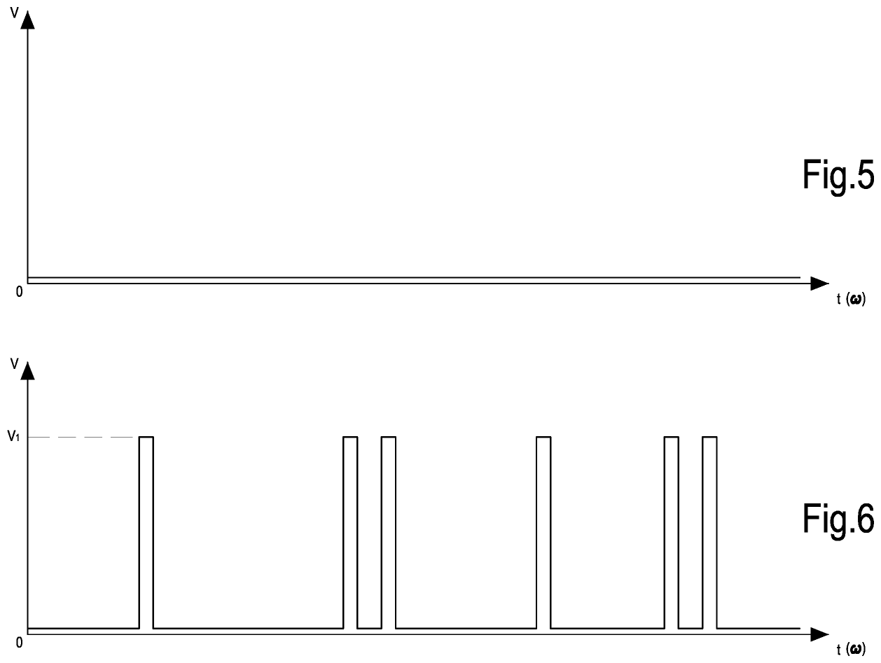

If the perforation blades 19 are arranged so as to obtain a continuous contact between at least a perforation blade 19 and the counter-blade 21, namely without interruption of the mutual contact between perforation blades 19 and counter-blade 21, the voltage signal is substantially continuous and low, as shown in FIG. 5. Malfunctions, due for example to missing areas of the cutting edges of blades and/or counter-blade, cause temporary opening of the measurement circuit and therefore voltage peaks, as shown schematically in the diagram of FIG. 6, where the X axis again shows the time and the Y axis the signal generated by the sensor.

In a further embodiment, in addition to or as a replacement of the sensor 104, a linear load cell, or an array of load cells, or in general one or more load sensors, can be positioned below the or each fixed counter-blade 21, 21B, 21C, to detect the load generated during the perforation, caused by the mutual interaction with the rotating perforation blades 19. In FIG. 2, the number 111 schematically shows load cells mounted at the ends of the beam 22 which carries the counter-blades 21, 21B, 21C. The load cells 111 are connected to the control unit 33.

Instead of two load cells 111 at the ends of the beam 22, a plurality of load cells can be provided distributed along the entire longitudinal extension of the counter-blades 21, 21B, 21C, for example between each counter-blade 21, 21B, 21C and the seat thereof obtained in the beam 22.

It is also possible, in general, to arrange the load cells in combination with the rotating perforation blades 19, but this is less advantageous as it requires a greater number of load sensors and also entails the need to transfer the signal generated by the load sensors from the rotating blade-holder 15 to the fixed electronic control unit 33.

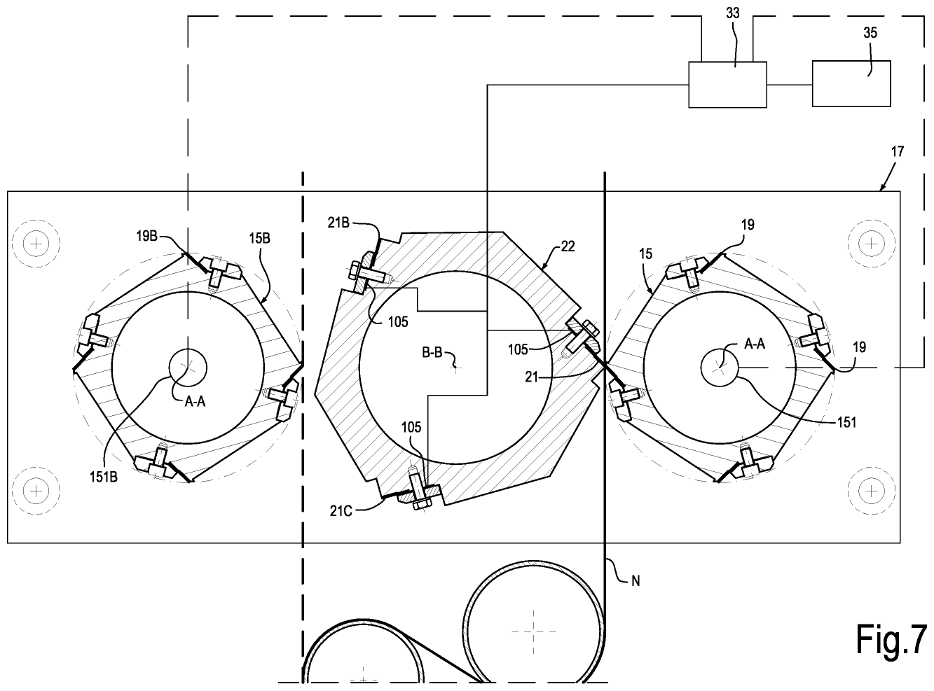

FIG. 7 shows load sensors, for example load cells 105 associated with each fixed counter-blade 21; 21B; 21C. The sensors 105 are interfaced to the electronic control unit 33. The remaining components, substantially identical or equivalent to those already described, are indicated by the same reference numbers and not described again.

The load cells can be used in combination with the sensor 104, as described above. However, the possibility of using only the load cells or other sensors adapted to detect a force exchanged between counter-blade and respective rotating blade co-acting with it is not ruled out.

Also in this case irregularities in the signal of one or more of the load cells 105 or 111 indicates perforation carried out incorrectly or even no perforation. Furthermore, from the analysis of the load signal generated by interaction of the fixed counter-blade 21 with the rotating perforation blades 19 it is possible to tell whether the interference between rotating blades and counter-blade is excessive (excess load) or too low (little interaction between blades and counter-blade). According to this signal it is possible to automatically adjust the interaction of the rotating perforation blades 19 with the fixed counter-blade 21; 21B; 21C to restore correct execution of the perforations.

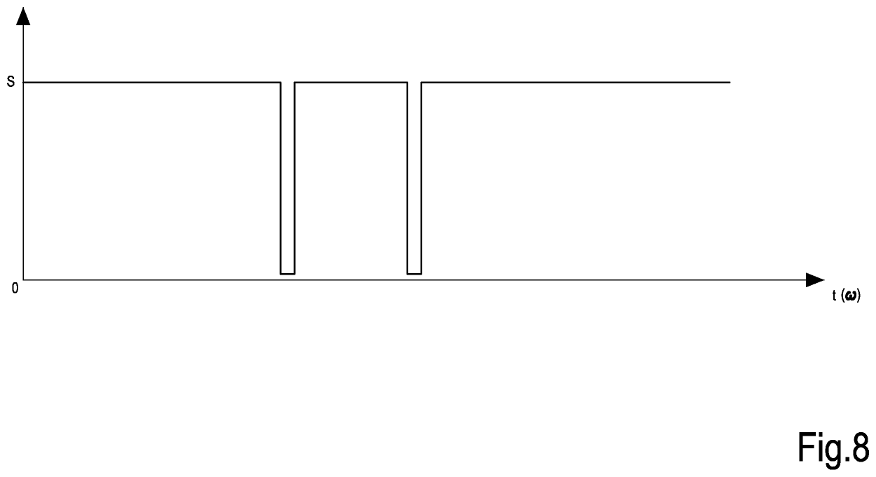

FIG. 8 illustrates a simplified exemplifying diagram that shows the load sensor signal on the Y axis as a function of time (on the X axis). The value S of the signal is indicative of the interference between rotating perforation blades and counter-blade and can be adjusted so as to bring it to the required value, increasing or reducing the distance between blade-holder 15 and beam 22. The signal of FIG. 8 is generated in the case of continuous contact between perforation blades 19 and counter-blade 21. The points in which the signal drops suddenly are indicative of a malfunction, for example broken sections of the cutting edges of blades 19 and counter-blade 21.

In embodiments disclosed herein, each rotating blade-holder 15, 15B is associated with an angular position sensor, for example an angular encoder. In the diagram of FIG. 1 the angular position sensors of the two blade-holders 15, 15B are indicated by 151 and 151B respectively. Each angular position sensor 151 and 151B is connected to the control unit 33 by means of lines 153 and 153B respectively.

The control unit 33 receives from the angular position sensor 151, 151B of the rotating blade-holder in use (15 or 15B) and from the mutual contact sensor, for example sensor 104, signals that allow each angular position of the respective rotating blade-holder 15, 15B to be associated with a mutual contact signal between one of the rotating blades 19, 19B and the counter-blade 21, 21B, 21C currently in use. The control unit 33 can sample the signals received so as to associate, with each of a plurality of points, or discrete areas, of each rotating blade 19 or 19B of the blade-holder 15 or 15B, a signal of contact or non-contact with the fixed counter-blade 21, 21B or 21C. In fact, for each rotating blade-holder 15, 15B, each angular position of the blade-holder can correspond to a given point (understood as discrete area or given portion) of the cutting edge of at least one rotating blade 19 or 19B carried by the rotating blade-holder 15, 15B.

If, as indicated above, the arrangement of the rotating blades and of the fixed counter-blades is such that in each angular position of the rotating blade-holder 15, 15B in use there is at the most a single blade in contact with the counter-blade 21, 21B, 21C selected and in use, then each angular position of the rotating blade-holder 15, 15B corresponds to a point or portion of the cutting edge, namely of the longitudinal extension, of one of the rotating blades 19, 19B carried by the blade-holder 15 or 15B, and therefore correspondingly a point of the longitudinal extension, namely of the cutting edge, of the counter-blade 21, 21B, 21C in use.

The control unit 33 can be programmed to sample the signal of the mutual contact sensor, for example the sensor 104 for a plurality of angular positions for each rotation of the rotating blade-holder 15 or 15B in use, and therefore for a plurality of points or portions of the longitudinal extension of each blade 19 or 19B. Sampling can be carried out for each rotation of the blade-holder 15, 15B, or for some appropriately selected complete rotations, for example one rotation every two or every three, every five or every ten.

By ordering the signals coming from the mutual contact sensor according to the angular position of the rotating blade-holder 15 or 15B in use, it is possible to generate, by means of the control unit 33, a representation of the operating conditions of each rotating blade 19 or 19B, namely a linear map of the mutual contact between each blade 19 or 19B and the respective counter-blade 21, 21B, 21C.

Supposing, for example, three rotating blades 19 are provided (as shown in the drawing) and supposing that in each angular position of the rotating blade-holder 15 there is a single point (or portion) of contact of a single rotating blade 19 with the counter-blade 21, 21B or 21C, by means of the control unit 33 it is possible to generate, for example on a monitor forming part of the human-machine interface 35, a representation of the mutual contact conditions between each rotating blade 19 and the counter-blade 21, 21B or 21C.

The representation can consist for example of a line of points on the monitor for each rotating blade, in which each point corresponds to a physical point or portion of the respective rotating blade, in the area of which the control unit 33 samples the signal of the mutual contact sensor.

In other words, the signal of the contact sensor 104 can be associated with the angular position of the blade-holder 15 or 15B detected by the respective angular position sensor, thus reconstructing the contact profile of each blade 19, 19B. This is possible because each angular position of the blade-holder 15, 15B corresponds to a contact point or area between blade 19, 19B and counter-blades 21, 21B, 21C. Furthermore, at each angular position of the blade-holder 15, 15B it is possible to know which of the blades 19 is in mutual contact with the counter-blades 21, 21B or 21C and thus detect point by point the contact or the absence of contact between blades 19, 19B and counter-blades 21, 21B, 21C.

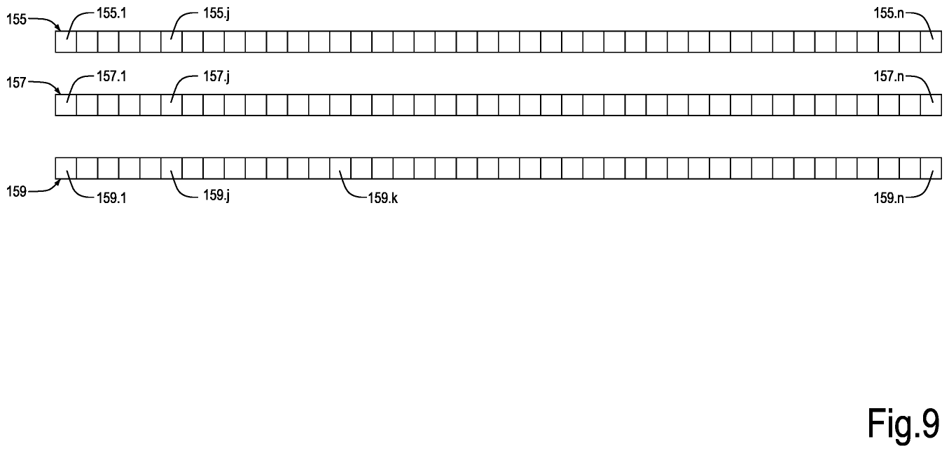

FIG. 9 schematically shows a graph that can be displayed on a monitor or on a display of the human-machine interface 35, with three lines of points, said lines representing the three blades 19 or 19B of the rotating blade-holder 15 or 15B. The number 155 indicates a line of points or squares 155.1, . . . 155.j . . . 155.n, corresponding to n physical points or physical portions along the cutting edge of one of the three rotating blades 19. The numbers 157 and 159 indicate lines of points or squares 157.1, 157.2, . . . 157.j, . . . 157.n and 159.1, 159.2, . . . 159.j, . . . 159.n representative of points or areas along the longitudinal extension, namely along the cutting edges of the other two rotating blades 19. In short, the point 155.1 and the point 155.n represent the first and the last sampling point along the longitudinal extension of the first rotating blade 19 (or 19B), the point 157.1 and the point 157.n represent the first and the last sampling point along the longitudinal extension of the second rotating blade 19 (or 19B), and the point 159.1 and the point 159.n represent the first and the last sampling point along the longitudinal extension of the third rotating blade 19 (or 19B).

Each square 155.1, . . . 155.n, 157.1, . . . 157.n, 159.1, . . . 159.n can for example take two different colors (e.g. green and red), according to the signal which the mutual contact sensor generates in the area of the angular position of the blade-holder 15 or 15B corresponding to the point of contact of one of the rotating blades with the counter-blade. If the mutual contact sensor is represented by the sensor 104 of an electrical parameter, the signal can be a signal that takes exclusively two values, corresponding selectively to presence or absence of mutual contact between rotating blade and counter-blade, independently of the force exchanged between blade and counter-blade, namely independently of the interference between blade and counter-blade.

If the mutual contact sensor consists of one or more load cells, for example load cells 111 and/or 105, the signal can take a value varying between a minimum (for example a null value) and a maximum. The value of the signal is proportional to the degree of interference between each rotating blade 19 and the counter-blade 21. In this case each square of the lines 155, 157, 159 can take for example colors varying from a color representative of absence of mutual contact (for example red, corresponding to a null signal of the load sensor or load cell) to a color (for example green) representative of an optimal force exchanged between blade and counter-blade. Since the interference between blade and counter-blade must not be excessive in order not to damage or prematurely wear the blades and the counter-blades, the color of each point or square of the lines 155, 157, 159 can be made to change from green to a different color, for example yellow, when the force exchanged exceeds a limit value, representative of a maximum permitted interference between blades and counter-blade.

In the case of a plurality of load cells 105 mounted along the fixed counter-blades

21, 21B, 21C, each sampling point could be made to correspond to a specific load cell.

In the case of two load cells 111 at the support ends of the beam 22 that carries the counter-blades 21, 21B, 21C, the signal provided to the control unit 33 can be a combination of the signals provided by the two load cells 111. These values change as the position of the point of contact between rotating blades 19 and counter-blade 21, 21B or 21C varies; said position is identified by the angular position sensor 151A, 151B. For example, the control unit 33 can add together the two signals coming from the two load cells 111, since with the variation in the position of the mutual contact point between blade and counter-blade from one end to the other of the longitudinal extension of the blades and the counter-blade, the signal of one of the two load cells 111 increases while the other decreases.

In some embodiments, the mutual contact sensor can comprise both a sensor 104 that detects an electrical parameter, for example a voltage, and a system of load cells, to detect the contact and the entity of the force exchanged between blade and counter-blade.

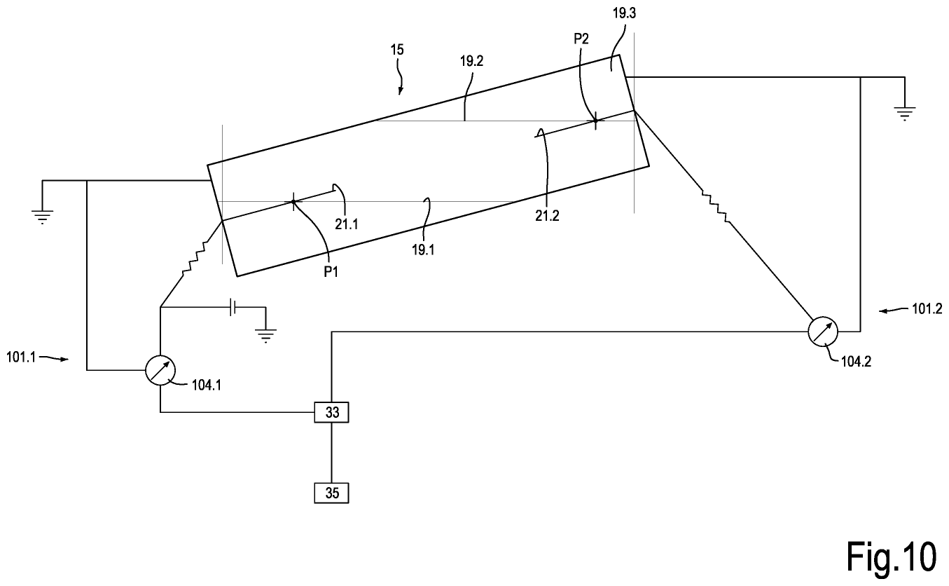

If the arrangement of the rotating blades is such that in each angular position of the blade-holder two blades 19 are in contact with the counter-blade 21, 21B or 21C, the counter-blade can be divided into two counter-blade portions, and a mutual contact sensor can be associated with each counter-blade portion. A configuration of this type is shown very schematically in FIG. 10. This figure schematically shows the blade-holder 15 with a plurality of blades 19.1, 19.2, 19.3. The numbers 21.1 and 21.2 indicate two portions into which the counter-blade 21 is divided. In the position indicated in FIG. 10, the rotating blade 19.1 is in contact in the point or area P1 with the portion 21.1 of the counter-blade 21, while the rotating blade 19.2 is in contact in the point or area P2 with the portion 21.2 of the counter-blade 21. Each portion 21.1 and 21.2 of the counter-blade is associated with a respective mutual contact sensor 104.1 and 104.2, inserted in respective circuits 101.1 and 101.2. Each circuit 101.1 and 101.2 is equivalent to the circuit 101 described above.

The sensor 104.1 detects the contact of a rotating blade 19.1, 19.2, 19.3 with the portion 21.1 of the counter-blade 21, while the sensor 104.2 detects the contact of a blade 19.1, 19.2, 19.3 with the portion 21.2 of the counter-blade 21. The two sensors 104.1, 104.2 are connected to the control unit 33 and form overall the mutual contact sensor between rotating blades and counter-blade.

When the blade-holder 15 rotates, the point or zone of contact P2 translates towards the right-hand end (in the figure) of the counter-blade 21 until it loses contact with the counter-blade 21, while the point or zone of contact P1 translates from left to right passing from the portion 21.1 to the portion 21.2 of the counter-blade 21. When the point or zone P1 passes from the portion 21.1 to the portion 21.2, the next blade begins the contact with the portion 21.1 of the counter-blade 21. In this way, rotating the blade-holder 15 around its own axis, there will always be two points or zones of contact P1, P2 of two different consecutive blades with the two portions 21.1, 21.2 of the counter-blade 21. The central unit 33 will always receive two different signals from the two sensors 104.1 and 104.2 which overall form the mutual contact sensor. In this way it is possible to distinguish the two blades which are at all times in contact with the counter-blade 21 and reconstruct on the interface 35 the lines of points 155, 157, 159 described above (FIG. 9), to provide information on the existence or otherwise of a correct mutual contact between each blade 19.1, 19.2, 19.3 etc., and the counter-blade 21.

During operation of the perforation device 3, if the mutual position of the blades 19 or 19B and the counter-blade 21, or 21B or 21C is correct, the lines 155, 157, 159 on the monitor or other interface are all formed of green points or squares. If one or more points or squares 155.i, 157i or 159.i (with i=1-n) on one or more of the lines 155, 157, 159 changes color, becoming red, this means that in the corresponding areas of the cutting edge of one or more of the blades, or counter-blade, a condition of non-contact occurs. This can be due for example to a breakage. If a portion of one of the rotating blades 19 or 19B breaks, one or more adjacent points on one of the lines 155, 157, 159 will change color (for example from green to red). If the breakage has occurred on the fixed counter-blade 21, 21B or 21C, then one or more points or squares of all the lines 155, 157, 159 will change color, in the same position on each line, for example the squares 155.5, 157.5 and 159.5 can become red. Based on where and how the color change is located, it is possible in this way for the operator to know if the breakage has occurred on the counter-blade or on one of the rotating blades, and in this case on which of the rotating blades.

Gradual wear or an error in the angular position of the axis of the blade-holder and/or of the counter-blade can cause a gradual variation in the color of the lines of light points from one end towards the other, or also from an intermediate point towards one of the ends. In this case, it is possible to adjust the relative position of the rotating blade-holder 19 or 19B and the counter-blade 22 by moving the respective supports with respect to the sides of the supporting structure. The adjustment can be automatic, or controlled by an operator. The lines 155, 157, 159 of light points are an aid in the operation of restoring the correct mutual position.

The adjustment can performed by means of actuators associated with the end supports of the rotating blade-holder 15, 15B and/or with the beam 22 that supports the counter-blades 21, 21B, 21C.

If the adjustment aimed at restoring the correct mutual position between rotating blades and counter-blade does not achieve the desired result with an acceptable shift of the blade-holder 15, 15B or of the beam 22 of the counter-blades, it may be necessary to replace the blades and/or the counter-blades that may be excessively worn or broken.

The arrangement described can be used also to carry out an initial positioning (zero point search) of the rotating blade-holder 15 or 15B with respect to the counter-blade 21, 21B, 21C. The zero point search can be carried out as follows.

The blade-holder 15 or 15B and the respective rotating blades are positioned in a position near to the counter-blade 21 (or 21B or 21C) that has been selected, but without mutual contact. The blade-holder 15 or 15B is then slowly rotated and the blade-holder 15 or 15B is moved gradually closer to the counter-blade. Initially the lines 155, 157, 159 of points will show a condition of absence of mutual contact. With the gradual movement of blade-holder and counter-blade closer to each other, the mutual contact sensor will signal a gradual contact between rotating blades and counter-blade, which will be displayed on the human-machine interface 35 by a gradual color change of the points 155.i, 157.i and 159.i which will change, for example, from red to green.

The mutual movement closer to each other between the rotating blade-holder 15 or 15B and beam 22 supporting the counter-blade 21, or 21B, or 21C can occur gradually in steps, by means of actuators that move the end supports of the blade-holder 15, 15B and of the beam 22. The zero point is defined by the position in which all the points 155.i, 157.i and 159.i become green (or in general a color that conventionally indicates correct mutual contact of the blades and counter-blade in the various points or zones of the cutting edge which are sampled by the mutual contact sensor).

Also in this case, if within a predetermined number of approach steps the color change of all the illuminated points 155.i, 157.i and 159.i is not obtained, it may be necessary for an operator to intervene, for example to correct a misalignment between blades and counter-blade.

The zero point search routine can be performed for example when one or more of the blades and/or counter-blades are replaced, or when the machine is re-started after an emergency stop, or whenever deemed appropriate.

As previously indicated, problems similar to those that can be encountered in the perforation devices of the type described above (for example used to perforate a cellulose web material fed to a rewinder for the production of rolls of toilet paper, kitchen paper and the like) can occur also in cutting devices that divide a web material made of detached mono or multi-ply sheets, for example a sheet of tissue paper, into single sheets that can be folded and stacked. A non-limiting example of machines that use cutting devices of this type are the so-called interfolding machines, which cut one or more webs of cellulose material to form packs of interfolded sheets.

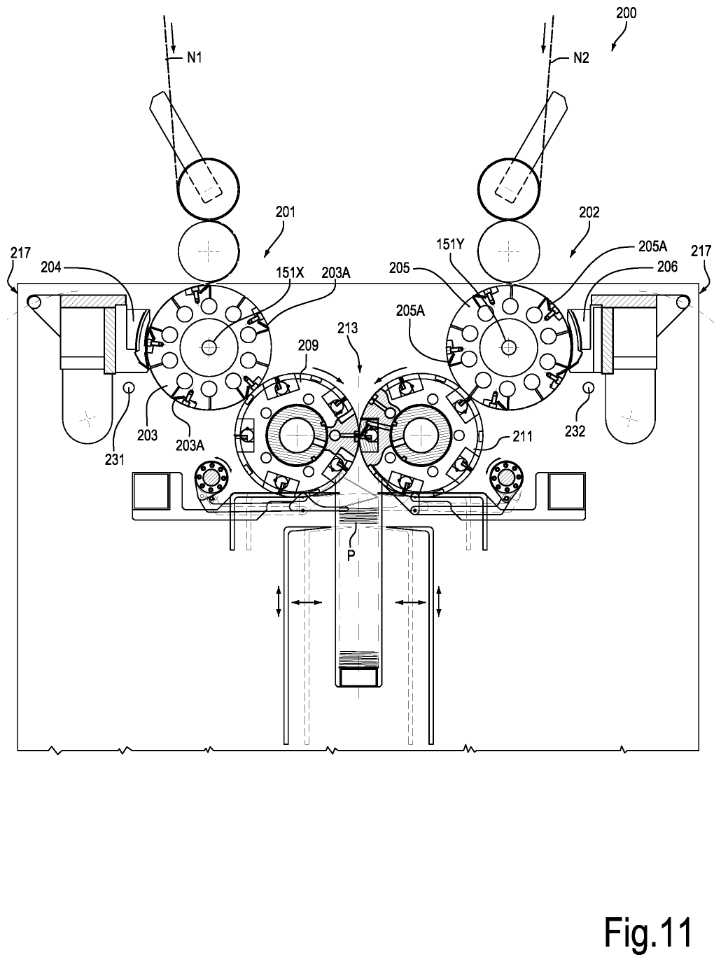

By way of example, FIG. 11 illustrates a frontal view of an interfolding machine which comprises two cutting devices. The interfolding machine 200 comprises a first feed path for a first continuous web material NI of tissue paper and a second feed path for a second continuous web material N2 of tissue paper. Along the first path a first cutting device 201 is arranged, which comprises a first rotating cutting roller 203 provided with angularly spaced rotating cutting blades 203A. The first rotating cutting roller 203 constitutes a blade-holder of the cutting device 201. The rotating cutting blades 203A co-act with a first stationary counter-blade 204. In the illustrated example the stationary counter-blade 204 has a helical shape, while the rotating cutting blades 203A have a rectilinear shape, parallel to the rotation axis of the blade-holder or rotating cutting roller 203. However, a reverse arrangement is not excluded, with a rectilinear stationary counter-blade and helical rotating cutting blades.

Along the second path a second cutting device 202 is arranged substantially mirroring the first cutting device 201. The second cutting device 202 comprises a rotating cutting roller 205, which is provided with angularly spaced blades 205A. The rotating cutting roller 205 forms a blade-holder of the cutting device 202. The blades 205A co-act with a second stationary counter-blade 206.

In a per se known manner, the first blade-holder or rotating cutting roller 203 and the second blade-holder or rotating cutting roller 205 are equipped with suction ports or other retaining means, to retain on the surface of the respective cutting rollers 203, 205 the sheets obtained by cutting the first and the second continuous web material N1, N2, and transfer said sheets from the cutting rollers 203, 205 to interfolding rollers 209, 211. Said interfolding rollers 209, 211 rotate around respective rotation axes parallel to each other and parallel to the rotation axes of the cutting rollers 203, 205. The two interfolding rollers 209, 211 form an interfolding nip 213. In a per se known manner, the interfolding rollers 209, 211 fold and interfold the sheets coming from the cutting devices 201, 202 to form a pile of sheets P.

Each continuous web material N1, N2 is guided around the respective rotating cutting roller 203, 205 and is fed between the cutting roller or rotating blade-holder 203, 205 and the stationary counter-blade 204, 206. The co-action of the rotating cutting blades 203A with the stationary counter-blade 204 cuts the continuous web material NI into individual sheets, which are then transferred from the first cutting roller or rotating blade-holder 203 to the first interfolding roller 209. Analogously, the continuous web material N2 is guided around the second cutting roller or rotating blade-holder 205 and cut into sheets by co-action of the rotating cutting blades 205A with the stationary counter-blade 206. The individual sheets are then transferred from the second cutting roller or rotating blade-holder 205 to the second interfolding roller 211.

The interfolding machine 200 shortly described so far is known per se. Other types of interfolding machines exist which have a single feed path for a single web material, and are again provided with at least one cutting device.

According to the description herein, independently of the specific structure of the machine, the/each cutting device 201, 202, with which the machine is equipped can be associated with a mutual contact sensor between rotating blades and the respective counter-blade. In FIG. 11, the number 231 schematically indicates a mutual contact sensor associated with the first cutting device 201 and the number 232 schematically indicates a mutual contact sensor associated with the second cutting device 202. Each mutual contact sensor 231, 232 can be provided in any one of the ways described above. The two mutual contact sensors 231 and 232 are preferably identical, but the possibility of using different sensors for the two cutting devices 201, 202 is not ruled out.

Each sensor 231, 232 can provide to a central control unit (not shown and analogous to the control unit 33 described above) a signal containing information on the correct operation of the respective cutting device 201, 202, in a manner substantially similar to what is described with reference to the perforation device of the previously illustrated exemplary embodiments. Similarly to what is described with reference to FIGS. 1 to 10, each rotating blade-holder can be associated with an encoder or other angular position sensor 151X, 151Y, to provide the control unit with an angular position signal. The control unit combines, as in the previous case, the signal coming from a mutual contact sensor with the angular position signal, to provide via an interface (FIG. 9) information on the correct co-action between blades and counter-blade and on the perfect condition of the blades and counter-blades for both the cutting units.

The control unit can be interfaced to a human-machine interface, in which information on the correct interference between rotating blades and counter-blades can be graphically shown in the form of lines of points or sections in different colors, as indicated by 155, 157 and 159 in FIG. 9. The user can therefore receive information analogous to that described previously and relative to the correct positioning and perfect condition of the cutting edges of the blades and counter-blades.

In the interfolding machines, and in general in machines in which the set of blades and counter-blades is used for cutting instead of perforation, the correct mutual co-action between blades and counter-blades can be particularly critical and delicate. In fact, if the cutting of each sheet of web material is incomplete, it can result in jamming and failure of the machine.

In the interfolding machines, and also in other machines that can operate at variable speed, the degree of interference between blades and counter-blades can vary as the speed varies. This can entail the need to modify the mutual position between blades and counter-blades according to the rotation speed of the rotating blades. The system described here, which detects the presence and if necessary the degree of interference (via load cells and similar) between blades and counter-blades, can serve as a correct operating control of the machine when the operating speed varies and can be used to modify the mutual distance between counter-blade and axis of the rotating blade-holder of each cutting unit as the machine operating speed varies and therefore as the rotation speed of the rotating blade holder varies.

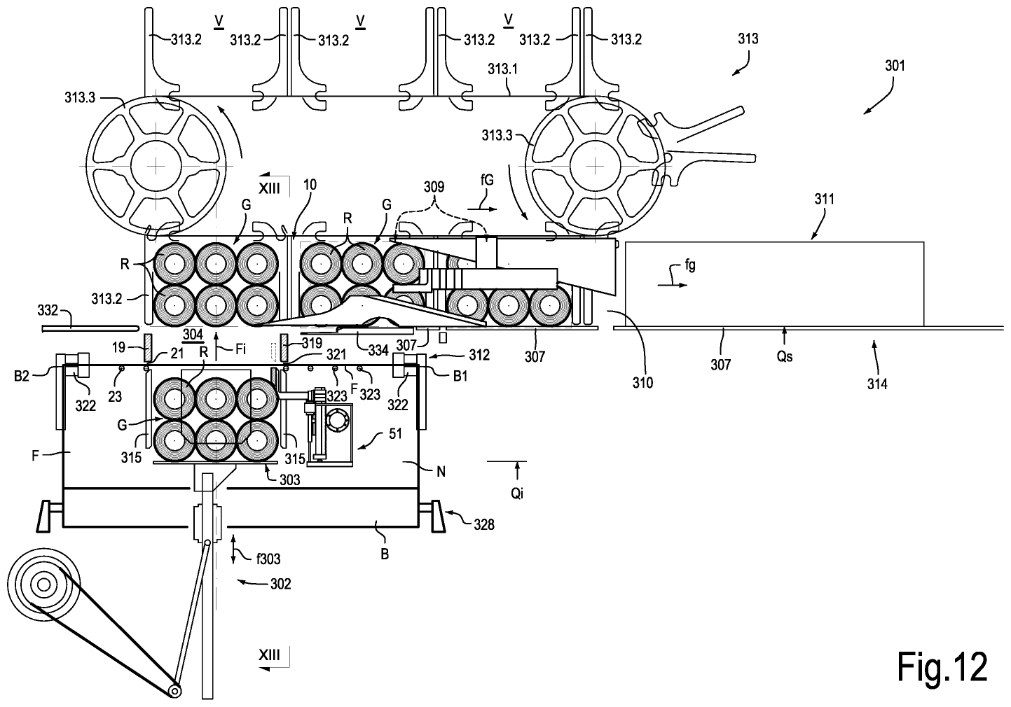

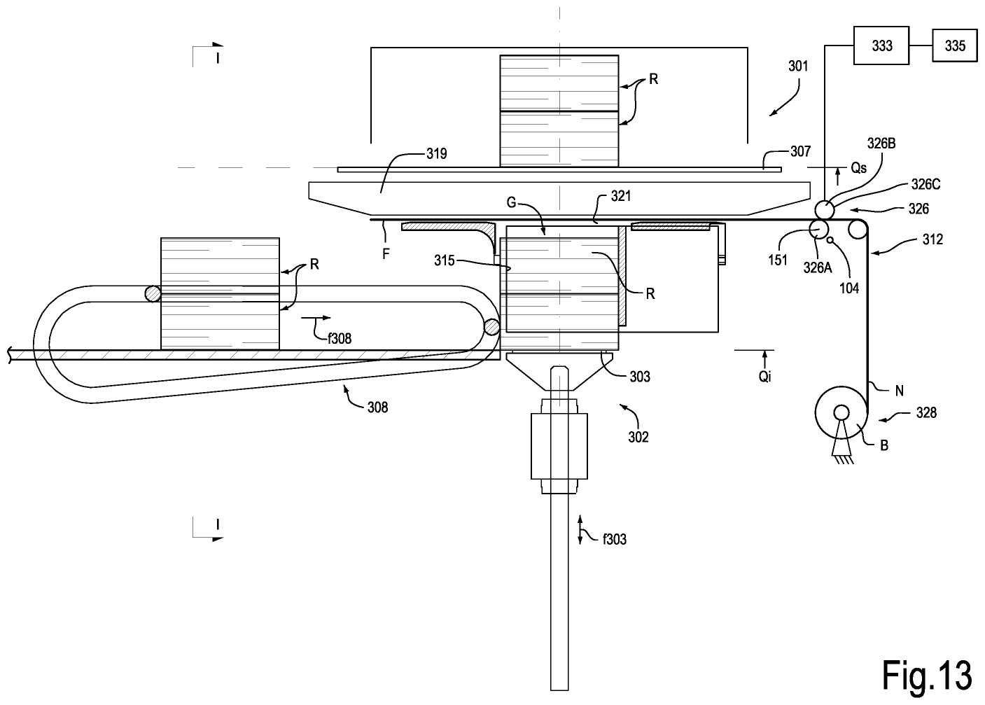

In the previously described embodiments reference was made to systems for cutting and perforating a web material forming the semi-finished product from which the finished product is obtained in the form of packs of interfolded sheets or rolls. However, the detection system described for detecting operation of the blades and counter-blades can also be used in cutting or perforation units of other types and for other purposes. FIGS. 12 and 13 illustrate a packaging machine for packaging groups of rolls or other tissue paper products, which comprises a system for unwinding a reel of web material which is divided into wrapping sheets for packaging the groups of rolls. A packaging machine of this type is disclosed in detail for example in IT1426528, EP2766266, EP1228966 and below will be described only summarily, in order to illustrate the use therein of a new cutting system to divide the web material, for example a polymer film, a paper web or a bio-plastic web, into individual wrapping sheets.

The packaging machine 301 comprises an inserter 302 for inserting, according to an arrow Fi, groups of tissue paper products R via an insertion path 304 towards a feeding and packaging path 310, along which the tissue paper products R are fed according to the arrow fG and are packaged in a wrapping sheet F as described below in detail.

In the example illustrated, the products R are rolls of tissue paper, for example rolls of toilet paper.

The inserter 302 comprises an elevator 303 provided with a movement in a substantially vertical direction, indicated by the double arrow f303.

The elevator 303 has the function of lifting groups G of tissue paper products R from a lower height Qi, to which the products are fed by a feed unit 308 (FIG. 13), to an upper height Qs, where there is a sliding surface 307, along which the groups G of products R are fed to complete the packaging cycle and obtain the package.

Feeding of the groups G of products R according to the arrow fG is obtained by means of a conveyor 313. In the embodiment illustrated, the conveyor 313 comprises flexible members 313.1, to which teeth 313.2 are secured. The latter define compartments V for receiving and feeding the groups G of products R. The flexible members 313.1 are relayed around relay wheels 313.3, appropriately motorized to move the flexible members 313.1 and therefore the teeth 313.2 along a closed path. The active branch of the closed path is the lower branch, in the area of which the groups G of products R are inserted in the compartments V and are fed in the direction of the arrow fG.

The conveyor 13 can be designed for example as disclosed in EP1655230, EP3625132.

As can be seen in FIGS. 1 and 2, above the height Qi guide walls 319 are provided, the lower edges of which form, with the upper edges of two lateral walls 315, two slots 321 for inserting and positioning a wrapping sheet F, for example made of polymer material, plastic of vegetable origin (or bioplastic), paper or other.

The wrapping sheet F is fed and positioned along the insertion path by means of

a positioning device indicated overall by 312.

In some embodiments, the wrapping sheet F is obtained by cutting for the required length a web material N unwound from a reel B positioned in an unwinder 328 forming part of the positioning device 312. To cut the continuous web material N unwound from the reel B, a cutting or perforation device may be provided, schematically indicated by 326 (FIG. 13).

The web material N unwound from the reel B passes through the slots 321. In advantageous embodiments, the web material N is driven by means of belts or other feed members 322, forming part of the positioning device 312, which engage longitudinal edges B1, B2 of the web material N and unwind it on a substantially horizontal geometrical plane, passing through the two slots 321 and intersecting the insertion path 304.

To support the wrapping sheet F in a roughly flat position, the positioning device 312 can comprise support elements 323, for example in the form of bars extending parallel to the longitudinal edges B1, B2 of the wrapping sheet F laid flat and extending through the slots 321.

When a group G of products R has been arranged on the elevator 303, the latter is raised (arrow f303) until it brings the group G of products R to the upper height Qs where the sliding surface 307 of the feeding and packaging path 310 is located. Each group G of products R is inserted in this way in one of the compartments V defined by the teeth 313.2 of the conveyor 313. In the lifting movement, the group G of products R is partially wrapped by the wrapping sheet F.

Once the group G of products R has been inserted in the respective compartment V of the conveyor 313, it is fed in the direction of the arrow fG through a folding unit 309 and a welding unit 311. Passing between the guide walls 319, the group G of products R engages the wrapping sheet F and obliges it to arrange itself around two lateral faces and the upper face of the group G of products R.

Roughly at the level of the sliding surface 7 two lower folders 332, 334 are arranged, forming part of the folding unit 309, which move horizontally towards each other to fold the wrapping sheet F below the group G of products R and overlap the edges B1, B2, while the elevator 303 is lowered again to the lower height Qi to collect a new group G of products R to be packaged.

Continuing to move along the feeding and packaging path 310, the group G of products R passes through lateral folder members, which fold the lateral edges of the wrapping sheet F against the lateral faces of the group G of products R. Lateral folding members L1, L2 can be provided for example as disclosed in EP1228966.

When they leave the folding members, the groups G of products R, wrapped in the wrapping sheet F, are transferred by the conveyor 313 to a closing system 314. As indicated above, in the illustrated embodiment the closing system 314 comprises a welding system 311, which heats the wrapping sheet F to a temperature such as to cause partial fusion thereof. The subsequent cooling mutually joins the folded edges of the film or wrapping sheet F on the lateral faces of the group G of products R, definitively stabilizing the wrapping sheet F around the package of products R thus obtained.

The cutting device 326 can comprise a fixed counter-blade 326A and a blade-holder 326B which carries one or more rotating blades 326C. The cutting device 326 can comprise a mutual contact sensor 104 and an angular position sensor 151, made in one of the ways described above with reference to the preceding figures. The mutual contact sensor and the angular position sensor, associated with the rotating blade-holder 326B, can be connected to a control unit schematically indicated by 333, to which an interface 335 is connected. On the interface 335, analogously to the previous description, information can be presented in graphic form relative to the presence or absence of contact between each rotating blade 326C and the fixed counter-blade 326A in a plurality of points distributed along the longitudinal cutting edge of the fixed counter-blade 326A and the rotating blade 326C.

By means of the combined information of the mutual contact sensor and angular position sensor, it is possible to detect any absence of mutual contact between blade and counter-blade, or partial mutual contact that can be due to incorrect positioning of rotating blade and counter-blade or breakage of the blade or counter-blade.

While the invention has been described in terms of various specific embodiments, it will be clear to persons skilled in the art that many modifications, variations or omissions are possible, without departing from the spirit and the scope of the claims.

For example, in the embodiments described, the mutual contact signal is detected by sensors associated with the fixed counter-blade. This is technically simpler, but does not exclude the possibility of the signal being detected by the rotating blade-holder. In this case we can have a mutual contact sensor for each rotating blade. The signal can be transmitted to the central unit 33 by means of a wireless connection, or by means of a rotating collector.

In the preceding description, reference is made to a mutual contact sensor that detects an electrical parameter and a mutual contact sensor that comprises one or more load cells or other force transducers. The two systems can be integrated, in the sense that it is possible to use a mutual contact sensor that generates an on-off signal, according to whether there is or not mutual contact between rotating blades and counter-blades, and an arrangement of sensor elements adapted to detect the contact between blades and counter-blades, for example elements comprising load cells. In this way it is possible to obtain more detailed information, which indicates both whether there is mutual contact or not, and the entity of the force exchanged between blade and counter-blade, namely the degree of interference between blade and counter-blade in the various points of mutual contact along the cutting edges. The use of load cells or other force sensor elements allows the degree of mutual interference between blades and counter-blade to be modified, for example according to the operating speed of the machine, the type of web material to be processed, or other process parameters.

Given that when blade and counter-blade are not in contact the mutually exchanged force is null, a system of load cells or other elements adapted to detect the force can be employed also without a mutual contact sensor that uses an electrical parameter.

1-29. (canceled)

30. A rotating blade device for processing a web material, comprising:
a supporting structure;
a rotating blade-holder, which rotates around a rotation axis and on which a set of rotating blades is arranged;
a counter-blade carried on said supporting structure and adapted to coact with said set of rotating blades;
wherein each rotating blade of said set of rotating blades and the counter-blade are configured so that, during rotation of the rotating blade-holder said each rotating blade and the counter-blade have a point of mutual contact at a first end of the rotating blade and out of mutual contact at a second end of the rotating blade, the point of mutual contact between said each rotating blade and the counter-blade shifting gradually from the first end to the second end of the rotating blade along a longitudinal extension of the rotating blade;
a mutual contact sensor adapted to detect presence or absence of the mutual contact between said each rotating blade and the counter-blade;
an angular position sensor, adapted to detect an angular position of the rotating blade-holder;
a device adapted to combine a signal of the mutual contact sensor and a signal of the angular position sensor and provide, for said each rotating blade, an indication of the presence or absence of the mutual contact between said each rotating blade and the counter-blade in a plurality of points distributed along a longitudinal extension of a respective one of said each rotating blade and the counter-blade.

31. The device of claim 30, wherein the mutual contact sensor is adapted to detect an electrical parameter associated with the set of rotating blades and with the counter-blade.

32. The device of claim 31, wherein the electrical parameter is a voltage applied between the counter-blade and the set of rotating blades.

33. The device of claim 32, wherein a reference voltage is applied to the counter-blade and the rotating blade-holder is connected to a ground potential, or a reference voltage is applied to the rotating blade-holder and the counter-blade is connected to a ground potential.

34. The device of claim 30, wherein the mutual contact sensor is adapted to detect a force exchanged between said each rotating blade and the counter-blade.

35. The device of claim 30, wherein the counter-blade is fixed with respect to the supporting structure.

36. The device of claim 30, wherein the set of rotating blades comprises at least one rotating blade arranged with a constant angular pitch around the rotation axis of the rotating blade-holder.

37. The device of claim 30, wherein said each rotating blade is arranged on the rotating blade-holder with a helical cutting edge thereof and the counter-blade has a rectilinear edge; or wherein said each rotating blade is arranged on the rotating blade-holder with a cutting edge thereof according to a straight line parallel to the rotation axis of the blade holder and the counter-blade has a helical cutting edge.

38. The device of claim 30, wherein the set of rotating blades and the counter-blade are arranged so that for each angle of rotation of the rotating blade-holder there is a single point of contact between only one rotating blade and the counter-blade.

39. The device of claim 30, wherein the set of rotating blades and the counter-blade are arranged so that for at least some angular positions of the rotating blade-holder there is a point of contact between the counter-blade and at least two rotating blades of said set of rotating blades; wherein the counter-blade is divided into a plurality of counter-blade portions of lengths such that in any angular position of the rotating blade-holder each counter-blade portion is in contact with only one rotating blade of said set of rotating blades; and wherein the mutual contact sensor is a multiple mutual contact sensor, with a mutual contact detection element for each counter-blade portion.

40. The device of claim 30, further comprising a control unit, adapted to receive the signal of the mutual contact sensor and the signal of the angular position sensor and to provide, for said each rotating blade, an indication of presence or absence of contact for a plurality of points distributed along a longitudinal extension of a respective one of said each rotating blade.

41. The device of claim 40, further comprising a human-machine interface connected to the control unit and adapted to display, for said each rotating blade, presence or absence of contact with the counter-blade for a plurality of points distributed along the longitudinal extension of the respective one of said each rotating blade.

42. The device of claim 41, wherein through the human-machine interface the control unit is adapted to receive, from an operator, controls for adjusting mutual interaction between the set of rotating blades and the counter-blade.

43. The device of claim 40, wherein the. control unit is adapted to automatically adjust mutual interaction between the set of rotating blades and the counter-blade and/or to generate a notification as a function of the signal provided by the mutual contact sensor.

44. The device of claim 30, wherein the set of rotating blades and the counter-blade are configured to make perforation lines along the web material, or cut lines along the web material and divide the web material into sheets.

45. The device of claim 30, further comprising at least one load cell adapted to detect a force exchanged between the counter-blade and the set of rotating blades.

46. The device of claim 45, wherein said at least one load cell comprises a first load cell and a second load cell, arranged on opposite sides of the device.

47. The device of claim 45, wherein said at least one load cell comprises a series of load cells distributed along a longitudinal extension of the counter-blade or of said each rotating blade.

48. The device of claim 45, wherein the control unit is interfaced with each load cell.

49. A machine for converting a web material, comprising a feed path of a web material, and rotating blade device for processing a web material; wherein the rotating blade device comprises:
a supporting structure;
a rotating blade-holder, which rotates around a rotation axis and on which a set of rotating blades is arranged;
a counter-blade carried on said supporting structure and adapted to coact with said set of rotating blades; wherein each rotating blade of said set of rotating blades and the counter-blade are configured so that, during rotation of the rotating blade-holder said each rotating blade and the counter-blade have a point of mutual contact at a first end of the rotating blade and out of mutual contact at a second end of the rotating blade, the point of mutual contact between said each rotating blade and the counter-blade shifting gradually from the first end to the second end of the rotating blade along a longitudinal extension of the rotating blade; wherein the feed path of the web material passes between the rotating blade-holder and the counter-blade;
a mutual contact sensor adapted to detect presence or absence of the mutual contact between said each rotating blade and the counter-blade;
an angular position sensor, adapted to detect an angular position of the rotating blade-holder;
a device adapted to combine a signal of the mutual contact sensor and a signal of the angular position sensor and provide, for said each rotating blade, an indication of the presence or absence of the mutual contact between the rotating blade and the counter-blade in a plurality of points distributed along a longitudinal extension of a respective one of the rotating blade and of the counter-blade.

50. The machine of claim 49, further comprising converting members of the web material.

51. The machine of claim 49, wherein said machine is a rewinder or an interfolder machine and the web material is a cellulose web.

52. The machine of claim 49, wherein the machine is a packaging machine; the web material is a web for wrapping; and wherein during operation the set of rotating blades and the counter-blade divide the web material into wrapping sheets for wrapping groups of products.

53. The machine of claim 49, wherein said machine operates at a variable speed; wherein the degree of interference between the set of rotating blades and the counter-blade of the rotating blade device varies as the speed varies; wherein the rotating blade device further comprises a control unit which is adapted to automatically adjust mutual interaction between the set of rotating blades and the counter-blade and/or to generate a notification as a function of the signal provided by the mutual contact sensor.

54. A method for processing continuous web material, comprising steps of:
feeding the continuous web material along a feed path between a counter-blade and a rotating blade-holder comprising a set of rotating blades coacting with the counter-blade;
acting on the web material through the coacting of each rotating blade of the set of rotating blades with the counter-blade; wherein the set of rotating blades and the counter-blade act on the web material with a scissors cut, so that said each rotating blade and the counter-blade coact with one another in a point that translates, during rotation of the rotating blade, from a first end of a respective one of said each rotating blade to a second end of a respective one of said each rotating blade along a longitudinal extension of the respective rotating blade and of the counter-blade;
generating a signal indicative of presence or absence of mutual contact between said each rotating blade and the counter-blade through a mutual contact sensor during interaction between said each rotating blade and the counter-blade while the point of contact between said each rotating blade and the counter-blade translates from the first end to the second end of the respective one of said each rotating blade;
associating the signal of the presence or absence of mutual contact with information relating to an angular position of the rotating blade-holder.

55. The method of claim 54, further comprising associating, for said each rotating blade and for a plurality of points of the longitudinal extension of the rotating blade, information relating to the presence or absence of mutual contact between said each rotating blade and the counter-blade.

56. The method of claim 54, comprising providing by a human-machine interface, information relating to the presence or absence of mutual contact between said each rotating blade and the counter-blade for a plurality of points along the longitudinal extension of the respective one of said each rotating blade.

57. The method of claim 54, wherein the rotating blade-holder supports a plurality of rotating blades of said set of rotating blades arranged according to a constant angular pitch.

58. The method of claim 54, further comprising automatically adjusting mutual interaction between the set of rotating blades and the counter-blade and/or generating a notification as a function of the signal of presence or absence of contact between said each rotating blade and the counter-blade.

59. The method of claim 54, wherein the acting on the web material through the coacting of the set of rotating blades and the counter-blade comprises perforating the web material, or cutting the web material into individual sheets.
